(19) United States
(12) Patent Application Publication
(10) Pub. No.: US 2006/0140693 A1
(43) Pub. Date: Jun. 29, 2006

(54) Image reading apparatus

(75) Inventor: Yoshitaka Takami, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/314,363

(22) Filed: Dec. 22, 2005

(30) Foreign Application Priority Data
Dec. 28, 2004 (JP) 2004-379435

(51) Int. Cl. G03G 15/00

(52) U.S. Cl. 399/377; 399/380

(57) ABSTRACT

An image reading apparatus which can prevent floating of an original disposed on an original table due to wind pressure when an original cover is opened. As an original holding mechanism having a thrust pin which is slidably guided in a direction perpendicular to an inner face of an original cover between a first position where a front end thereof is protruded from the inner face of the original cover and a second position where the front end thereof is positioned substantially the same level of elevation as the flexible sheet. The front end of the thrust pin is protruded from the inner face of the original cover by a pressing force of a spring or own weight of the thrust pin so that it has been contacting to a rear face of the original by protruding from an inner face of the original cover while the original cover has been opened.

### BACKGROUND OF THE INVENTION

1. Field of the Invention

The present invention relates to an original holding mechanism provided in an original cover of an image reading apparatus such as a scanner as a peripheral device of a personal computer, facsimile equipment, a copying machine or a printer having composition of functions of these apparatuses, for holding an original on an original table without displacement while image scanning.

2. Description of the Related Art

When an original cover of such as a scanner is opened, an original disposed on an original table may be displaced from a set position on the original table due to it is floated by wind pressure, or the original soars up from the original table and falls on a floor. On that occasion, when the original fallen from the original table gets under such as a copying machine, it is troublesome to take out the original from a space below the copying machine. Furthermore, when the original is fallen on the floor, it may be stained by adhesion of dust. Therefore, various original holding mechanisms provided in the original covers are conventionally proposed for preventing floating of the original from the original table.

For example, Japanese Laid-Open Patent Publication No. 2003-75941 shows a conventional original holding mechanism is provide in an original cover so that a side portion of an original positioning member which is made of a flexible sheet is made free without being adhered on a pad (elastic member), and a holding member is rotatably pivoted on a main frame of the original cover in the vicinity of the side portion of the original positioning member. Such an original holding mechanism provided in the original cover is purposed to prevent failure of reading of an original. When the original cover is closed, the free portion of the flexible sheet is thrust toward the original table by own weight of the holding member, so that the original is closely disposed on the original table. Furthermore, when the original cover is opened, the free portion of the flexible sheet is laggardly lifted up from the lift up of the main frame of the original cover due to its own weight. While the lift up of the main frame of the original cover, the original is thrust on the original table by the flexible sheet, so that the floating of the original from the original table can be prevented even though the negative pressure occurs.

The holding member, however, is provided for all over length in scanning direction, and it thrusts the original on the original table via the flexible sheet, so that it is necessary to have a heavy weight. As a result, total weight of the original cover is increased, and operationality of the original cover is reduced. Furthermore, the configuration of the original holding mechanism becomes complex, and the holding member is larger, so that the cost of the original holding mechanism is increased.

On the other hand, Japanese Laid-Open Patent Publication No. 6-175239 shows another original holding mechanism having a ribbon shaped elastic member for holding an original between the ribbon shaped elastic member and an original table for preventing displacement of the original on the original table. By such a configuration, simple and inexpensive original holding mechanism can be provided, but a user must put the original between the ribbon shaped elastic member and the original table by manual operation, so that replacing operation of the original is very troublesome.

### SUMMARY OF THE INVENTION

The present invention is conceived to solve the above mentioned problems of the conventional original holding mechanism, and purposed to provide an image reading apparatus having an original holding mechanism of simple and inexpensive configuration by which floating of an original from an original table due to wind pressure when an original cover is opened.

An image reading apparatus in accordance with an aspect of the present invention comprises an original table on which an original is disposed, an original positioning member for positioning the original on the original table, an original cover which is rotatably pivoted by hinges and covers at least the original table and the original positioning member, and an original holding mechanism provided in the original cover for facing a thrust position spaced by predetermined distances from a reference position of the original positioning member in a main scanning direction and in a sub-scanning direction perpendicular to the main scanning direction when the original cover is closed.

The original holding mechanism being constituted so that it has been contacting to a rear face of the original by protruding from an inner face of the original cover while the original cover is gradually lifted up from a closed state and rotated around the hinges, thereby capable of preventing floating of the original from the original table due to wind pressure when the original cover is opened.

By such a configuration, the original disposed on an outer face of the original table is guided at two sides thereof by the original positioning member in the main scanning direction and in the sub-scanning direction, and is thrust to the original table by the original holding mechanism at the thrust position spaced by predetermined distances from the reference position of the original positioning member in the main scanning direction and in the sub-scanning direction. Thus, even when the wind pressure occurs due to opening the original cover, the original is never floated from the original table, and the position of the original on the original table is rarely displaced. Furthermore, the original is never fallen on a floor, so that a user is never bothered while a replacement operation of the originals.

In the above-mentioned image reading apparatus, it is preferable that the original holding mechanism has a thrust pin which is protruded by pressing force of a spring or own weight of the thrust pin.

By such a configuration, since the thrust pin which is slidably guided in the direction substantially perpendicular to the inner face of the original cover is used as the original guide mechanism, the configuration of the original holding mechanism becomes very simple and the cost of manufacture thereof can be reduced largely. Furthermore, since the thrust pin thrusts the original at a pinpoint, the size of the original holding mechanism becomes much smaller and the increase of the weight of the original cover can be restricted.

### BRIEF DESCRIPTION OF THE DRAWINGS

FIG. 1 is perspective view showing a configuration of an image reading apparatus in accordance with an embodiment of the present invention;

FIG. 2 is a sectional view showing a detailed configuration of an original holding mechanism in a condition that an original cover is opened in the embodiment;

FIG. 3 a sectional view showing a detailed configuration of the original holding mechanism in a condition that the original cover is opened; and

FIG. 4 is side view showing a motion of the original holding mechanism while the original cover is opened in the embodiment.

### DETAILED DESCRIPTION OF THE EMBODIMENT

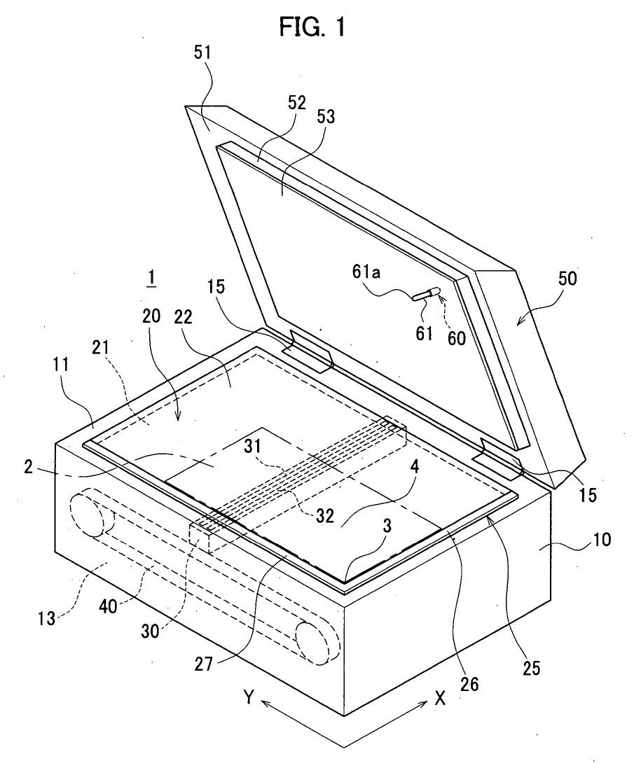

An image reading apparatus in accordance with an embodiment of the present invention is described with reference to figures. FIG. 1 is perspective view showing a configuration of the image reading apparatus 1 when an original cover is opened in the embodiment.

A rectangular aperture 12 is formed on a top face 11 of a housing 10, and a flat plate shaped original table 20 made of a transparent material such as a glass is fitted to the aperture 12. A scan unit 30 which is moved in a sub-scanning direction (first direction) designated by arrow Y with facing an inner face of the original table 20 and a driving mechanism 40 for reciprocally moving the scan unit 30 in the sub-scanning direction are provided in an inside 13 of the housing 10. The driving mechanism 40 may be one using a belt and pulleys as illustrated, or one using a linear motor or another mechanism.

The scan unit 30 is so-called CIS (Contact Image Sensor), and a linear light source (lighting means) 31 disposed along a main scanning direction (second direction) designated by arrow X and an imaging device (imaging means) 32 arranged in parallel with the linear light source 31 are provided on the scan unit 30. The linear light source 31 is configured by, for example, a plurality of light emitting devices such as LEDs (Light Emitting Devices) for illuminating a whole area in the main scanning direction substantially evenly. On the other hand, the linear light source 31 illuminates a predetermined area in the sub-scanning direction including at least a region imaged by the imaging device 32.

The imaging device 32 is configured by a lens array in which a plurality of minute lenses is arranged in the main scanning direction, and an array of light receiving elements in which a plurality of light receiving elements is arranged in the main scanning direction corresponding to the lenses. Each lens is focused on an outer face 22 of the original table 20, so that an image of a predetermined region illuminated by the linear light source 31 among of an original 2 closely disposed on the original table 20 are focused on light receiving faces of the light receiving elements of the imaging device 32. Specifically, the imaging device 32 images an image in a whole width of the original table 20 in the main scanning direction and in a width of the light receiving element in the sub-scanning direction (when the light receiving elements are arranged in a plurality of lines, a width of the plurality of lines of the light receiving elements).

An original positioning member (original positioning means) 25 having two sides 26 and 27 which are respectively parallel to the main scanning direction and the sub-scanning direction on the top face 11 of the housing 10. An intersection point of the side 26 and 27 is used as a reference position 3 for starting the image reading by the imaging device 32. Furthermore, an original cover 50 is pivoted openable and closable by hinges 15 on the top face 11 of the housing 10. In this embodiment, the reference position 3 for starting the image reading is located in front side of the top face 11 of the housing 10 (the side which is far from the hinges 15) when the original cover 50 is opened. The original 2 should be positioned with respect to the main scanning direction and the sub-scanning direction by contacting two sides of the original 2 which are orthogonal each other to the side 26 and 27 of the original positioning member 25.

The original cover 50 is substantially isometric with the top face 11 of the housing 10 so as to cover substantially whole of the top face 11 of the housing 10 including the original table 20 and the original positioning member 25. A flexible sheet 53 is attached to an inner face 51 of the original cover 50 via an elastic member 52 made of, for example, resin form. The flexible sheet 53 substantially isometric with the original table 20, so that the flexible sheet 53 is tightly contact to the original table 20 when the original cover 50 is closed.

Furthermore, an original holding mechanism 60 is provided in the original cover 50 so as to face a thrust position 4 which is spaced with a predetermined distance from the reference position 3 of the original positioning member 25 in each of the main scanning direction and the sub-scanning direction when the original cover 50 is closed. It is preferable that the thrust position 4 be located so that such as a post card which is relatively small paper sheet for printers in common use can be thrust by the original holding mechanism 60. However, the thrust position 4 or the position of the original holding mechanism 60 is not limited to the illustration, it may be other locations. Furthermore, a plurality of the original holding mechanisms 60 may be provided corresponding to each size of the paper sheet for printers.

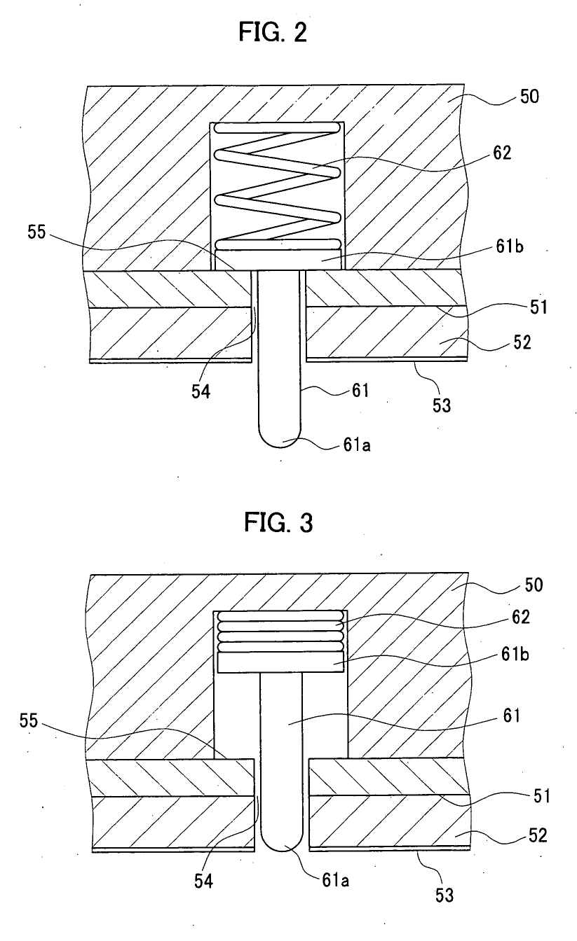

Subsequently, the configuration of the original holding mechanism 60 provided in the original cover 50 is described in detail with reference to FIGS. 2 and 3. The original holding mechanism 60 is comprised of a thrust pin 61 which slidably guided in a direction perpendicular to the inner face 51 of the original cover 50, and a spring 62 which is provided in the original cover 50 for applying elastic force to the thrust pin 61 so that a front end 61a of the thrust pin 61 protrudes outward from the inner face 51 of the original cover 50. A guide hole 54 for guiding the motion of the thrust pin 61 is further formed on the original cover 50. As shown in FIG. 2, when the original cover 50 is opened, the thrust pin 61 is pushed in protruding direction by the pressing force of the spring 62, so that a flange 61b contacts an end face 55 of the guide hole 54, and the front end 61a is protruded outward by a predetermined length from the inner face 51 (first position). On the other hand, as shown in FIG. 3, when the original cover 50 is closed, the front end 61a of the thrust pin 61 contacts the outer face 22 of the original table 20 or a rear face of the original 2 disposed thereon, and the thrust pin 61 is relatively pushed into the inside of the original cover 50 against the pressing force of the spring 62. At hat time, the front end 61a of the thrust pin 61 is positioned at substantially the same level of elevation as the flexible sheet 53 (second position). In addition, openings through which the thrust pin 61 penetrates are formed on the elastic member 52 and the flexible sheet 53.

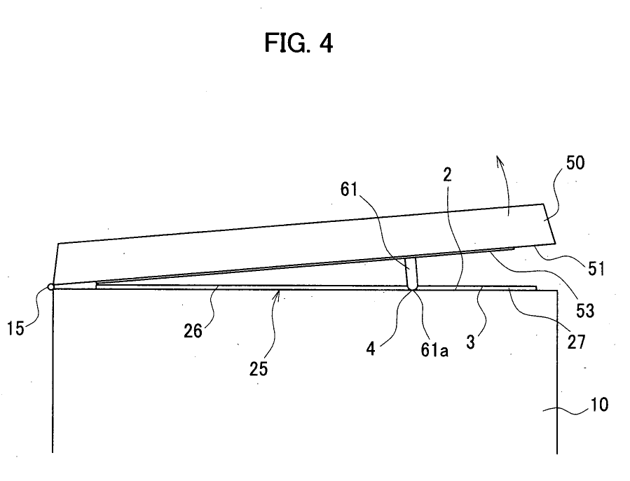

While the original cover 50 is gradually lifted up from a closed state and rotated around the hinges 15, the thrust pin 61 is relatively pushed outward from the original cover 50 by the pressing force of the spring 62. The thrust pin 61, however, has been thrusting the upper face 22 of the original table 20 or the rear face of the original 2 thereon until the flange 61b of the thrust pin 61 contacts the end face 55 of the guide hole 54, as shown in FIG. 4. At that time, the original 2 disposed on the outer face 22 of the original table 20 is guided at two sides thereof by the original positioning member 25 in the main scanning direction and in the sub-scanning direction, and is thrust to the original table 20 by the thrust pin 61 at the thrust position 4 spaced by predetermined distances from the reference position 3 of the original positioning member 25 in the main scanning direction and in the sub-scanning direction. Thus, even when the wind pressure occurs due to opening the original cover 50, the original 2 never be floated from the original table 20, and the position of the original 2 on the original table 20 is rarely displaced. Furthermore, the original 2 is never fallen on a floor, so that a user is never bothered while a replacement operation of the originals.

In this way, since the thrust pin 61 which is slidably guided in the direction substantially perpendicular to the inner face 51 of the original cover 50 is used as the original guide mechanism 60, the configuration of the original holding mechanism 60 becomes very simple and the cost of manufacture thereof can be reduced largely. Furthermore, since the thrust pin 61 thrusts the original 2 at a pinpoint, the size of the original holding mechanism 60 becomes much smaller and the increase of the weight of the original cover 50 can be restricted.

The present invention, however, is not limited to the description of the above-mentioned embodiment. It is sufficient that the image reading apparatus comprises the original table 20, the original positioning member 25 for positioning the original 2 on the original table 20, the original cover 50 which is rotatably pivoted by hinges 15 and covers at least the original table 20 and the original positioning member 25, and the original holding mechanism 60 provided in the original cover 50 for facing the thrust position 4 spaced by predetermined distances from the reference position 3 of the original positioning member 25 in the main scanning direction and in the sub-scanning direction when the original cover 50 is closed. The original holding mechanism 60 is constituted so that it has been contacting to the rear face of the original 2 by protruding from the inner face 51 of the original cover 50 while the original cover 50 is gradually lifted up from a closed state and rotated around the hinges 15, thereby capable of preventing the floating of the original 2 from the original table 20 due to the wind pressure when the original cover 50 is opened.

Furthermore, the image reading apparatus in accordance with the present invention can be modified in various manners. In the above-mentioned embodiment, the original holding member 60 is constituted so that the front end 61a of the thrust pin 61 is protruded from the inner face 51 of the original cover 50 by the pressing force of the spring 62. It, however, is possible to constitute that the front end 61a is protruded from the inner face 51 of the original cover 50 by own weight of the thrust pin 61. Still furthermore, the reference position 3 of the original may be provided in a side near to the hinges 15. Still furthermore, although the hinges 15 of for pivoting the original cover 50 is provided in parallel with the sub-scanning direction in the above-mentioned embodiment, the hinges 15 may be provided in parallel with the main scanning direction. Still furthermore, the scan unit 30 is not limited to the CIS, and the scan unit 30 may be a thing of so-called mirror scan type in which an image of the original is focused on an imaging device such as a CCD provided at a position distant from the scan unit 30 through a mirror and a lens.

This application is based on Japanese patent application 2004-379435 filed Dec. 28, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. An image reading apparatus comprising:
an original table on which an original is disposed;
an original positioning member for positioning the original on the original table;
an original cover which is rotatably pivoted by hinges and covers at least the original table and the original positioning member; and
an original holding mechanism provided in the original cover for facing a thrust position spaced by predetermined distances from a reference position of the original positioning member in a main scanning direction and in a sub-scanning direction perpendicular to the main scanning direction when the original cover is closed,
the original holding mechanism being constituted so that it has been contacting to a rear face of the original by protruding from an inner face of the original cover while the original cover is gradually lifted up from a closed state and rotated around the hinges, thereby capable of preventing floating of the original from the original table due to wind pressure when the original cover is opened.

2. The image reading apparatus in accordance with claim 1, wherein
the original holding mechanism has a thrust pin which is protruded by pressing force of a spring or own weight of the thrust pin.

3. An image reading apparatus comprising:
a housing having a rectangular aperture on its top face;
a flat plate shaped original table made of a transparent material and fitted to the aperture of the housing;
a scan unit provided in an inside of the housing and moved in a first direction with facing an inner face of the original table;
an illumination means provided on the scan unit and illuminating a predetermined area in each of the first direction and a second direction perpendicular to the first direction;
an imaging means provided on the scan unit and imaging an image in the predetermined area illuminated by the illumination means;
an original positioning means provided on the top face of the housing and having two sides respectively substantially parallel to the first direction and the second direction, an intersection point of the two sides serving as a reference point for starting image reading by the imaging means;
an original cover rotatably pivoted by hinges on the top face of the housing, and covering at least the original table and the original positioning member;
a flexible sheet attached to an inner face of the original cover via an elastic member, and substantially isometric with the original table so that the flexible sheet is tightly contact to the original table when the original cover is closed; and
an original holding mechanism provided in the original cover for facing a thrust position spaced by predetermined distances from a reference position of the original positioning member in a main scanning direction and in a sub-scanning direction perpendicular to the main scanning direction when the original cover is closed,
the original holding mechanism having a thrust pin slidably guided between a first position where a front end thereof is protruded from the inner face of the original cover and a second position where the front end thereof is positioned substantially the same level of elevation as the flexible sheet;
the front end of the thrust pin is protruded from the inner face of the original cover by a pressing force of a spring or own weight of the thrust pin so that it has been contacting to a rear face of the original by protruding from an inner face of the original cover while the original cover is gradually lifted up from a closed state and rotated around the hinges, thereby capable of preventing floating of the original from the original table due to wind pressure when the original cover is opened.
